(19) United States
(12) Patent Application Publication
(10) Pub. No.: US 2013/0037586 A1
(43) Pub. Date: Feb. 14, 2013

(54) Suspended Cup Holder

(71) Applicants: William Richter, Atlantic Beach, FL (US); Jennifer DeVore, Jacksonville, FL (US)

(72) Inventors: William Richter, Atlantic Beach, FL (US); Jennifer DeVore, Jacksonville, FL (US)

(21) Appl. No.: 13/205,700

(22) Filed: Aug. 9, 2011

(51) Int. Cl. B62J 11/00; B60R 9/00

(52) U.S. Cl. 224/401; 224/414

(57) ABSTRACT

A suspended cup holder comprising a support ring hanging from a plurality of elastic ring suspenders, and a basket suspended from the support ring by a plurality of elastic basket suspenders. The bottom of each ring suspender is attached to the ring, and the top of each ring suspender is attached to a support bracket. The support bracket is configured to attach the cup holder to a bicycle or hand cart. The elastic ring suspenders are any elastic member configured to support the support ring under the load of the beverage container. The support ring is a rigid or semi-rigid ring providing annular suspension support to the basket. The elastic basket suspenders are disposed circumferentially around the support ring and around the top of the basket. The basket is cylindrical in shape, the top being open to removably receive the beverage container, and the bottom having a base to provide vertical support to the beverage container.

### BACKGROUND

The present invention relates generally to cup holders adapted for attachment to bicycles and other hand-propelled devices, such as golf carts, lawn mowers, baby strollers, shopping trolleys, and the like. Conventional mobile cup holders are difficult to attach to bicycles and other moving carts. For example, bicycles often tilt, turn, sway, and jostle while being ridden, and cup holders rigidly attached to the bicycle tend to jostle the beverage, often causing spillage. Similar problems occur with other hand carts. In severe cases, the beverage container can be jarred loose from the holder, causing the entire beverage to be thrown from the cup holder.

One attempt to solve these problems is taught in U.S. Pat. No. 5,511,754 to Johannsen, which teaches elastic straps supporting a coil spring-like cup holder. However, the coil nature of the spring inherently causes a misalignment between the center of stiffness of the coil spring and the center of mass of the beverage. For example, the coil spring attaches to the ring in only one location on the side of the ring. This off-center misalignment causes the beverage to hang crooked in the cup holder, rendering it susceptible to typical jostling motion. In addition, as the beverage container experiences vertical oscillation inside the coil spring, the spring scrapes along the exterior surface of the beverage container in a chaffing motion. This motion can exacerbate the typical jostling, especially where the exterior surface of the beverage container is textured, contoured, or has protrusions such as handles.

The present invention seeks to overcome these problems by delivering a suspended cup holder capable of attaching to a variety of hand carts and bicycles while cradling the beverage in a suspended manner to reduce spillage caused by jostling motion.

### SUMMARY OF THE INVENTION

The suspended cup holder generally comprises a support ring suspended from a plurality of elastic ring suspenders, and a basket suspended from the support ring by a plurality of elastic basket suspenders. The bottom of each ring suspender is attached to the ring, and the top of each ring suspender is attached to a support bracket. The support bracket is configured to attach the cup holder to a bicycle or hand cart.

In one embodiment, the cup holder comprises two elastic ring suspenders, which are symmetrically attached to opposite sides of the support ring. The elastic ring suspenders are any elastic member configured to vertically suspend the support ring under the load of the beverage container. The elastic ring suspenders are fabricated from material suitable for the environmental conditions of the intended use.

The support ring is a rigid or semi-rigid ring providing annular suspension support to the basket. The connection between the elastic ring suspenders and the support ring can be accomplished by a variety of known connection members, such as hooks, clasps, links, loops, threaded fasteners, or the like. The same type of connection members can be used to attach the elastic basket suspenders to the support ring.

The elastic basket suspenders are disposed circumferentially around the support ring and around the top of the basket. In one embodiment, the elastic basket suspenders are disposed at equidistant radial intervals about the respective circumferences of the support ring and the top of the basket. The elastic basket suspenders are springs, elastic straps, or any other elastic material adapted to elastically support the basket. The elastic basket suspenders are fabricated from material suitable for the environmental conditions of the intended use.

The basket is approximately cylindrical in shape, the top being open to removably receive the beverage container, and the bottom having a base to provide vertical support to the beverage container. The basket can optionally comprise a collar disposed near the top of the basket. The collar is a rigid or semi-rigid ring configured to retain the top of the basket in an open position for ease of inserting the beverage container into, and removing it from, the basket. The basket can further comprise a base, which is any substantially horizontal member capable of abutting the bottom of a beverage container to provide vertical support to the container. The basket sides or base can comprise drain holes to drain unwanted liquid from the basket.

### BRIEF DESCRIPTION OF THE DRAWINGS

FIG. 1 shows the suspended cup holder hanging from a typical support bracket.

FIG. 2 shows an alternate embodiment of the support bracket and an embodiment of the suspended cup holder wherein the elastic ring suspenders comprise springs.

FIG. 3 shows an alternate embodiment of the basket of the suspended cup holder.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, or proportions shown in the figures.

### DETAILED DESCRIPTION

With reference to the drawings, the invention will now be described with regard for the best mode and the preferred embodiment. In general, the device is a suspended cup holder configured to attach to bicycles and hand carts. The following embodiments are presented in the context of bicycles and hand-propelled devices, such as baby strollers, golf carts, shopping trolleys, lawn mowers, other hand carts, and the like, all of which are included within the meaning of “hand cart” as used herein. However, the invention is not limited to attachment to such devices, and the embodiments disclosed herein are meant for illustration and not limitation of the invention. An ordinary practitioner will understand that it is possible to create many variations of the following embodiments without undue experimentation.

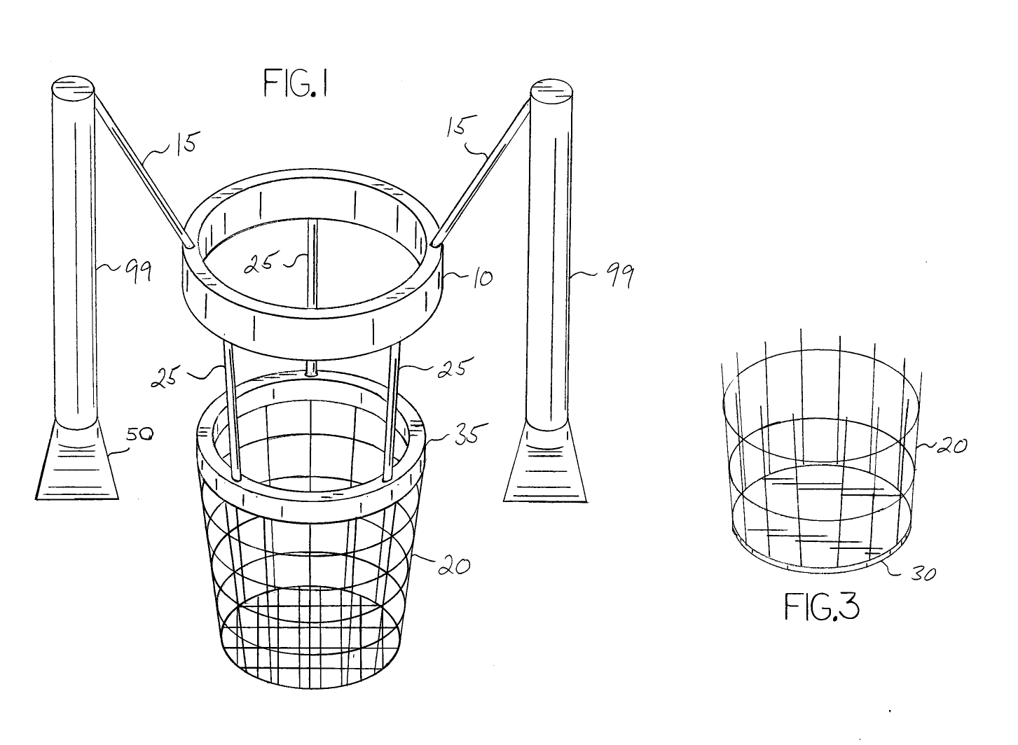

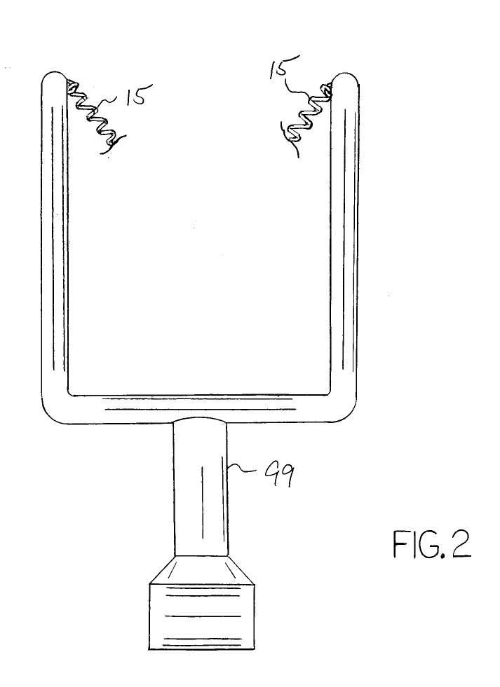

Referring to FIG. 1, the suspended cup holder generally comprises a support ring 10 suspended from a plurality of elastic ring suspenders 15, and a basket 20 suspended from the support ring 10 by a plurality of elastic basket suspenders 25. Each ring suspender 15 has a top end and a bottom end. The bottom end of each ring suspender 15 is attached to the support ring 10, and the top end of each ring suspender 15 is attached to a support bracket 99. The support bracket 99 is any bracket configured to attach the cup holder 1 to a bicycle or hand cart. For example, in one embodiment the support bracket 99 is a plurality of posts, each of which is attached at its bottom to the handle of a bicycle and attached at its top to the top end of a ring suspender 15. The attachment to the bicycle can be accomplished by a variety of connectors 50 known in the art. In another embodiment, as shown in FIG. 2, the support bracket 99 is a Y-shaped bracket attached at the base of its stem to the handlebar of a bicycle, and the ends of the Y arms are configured for attachment to the tops of the respective elastic ring suspenders 15. This attachment can be made by a variety of typical connection members, such as hooks, clasps, brackets, clamps, threaded fasteners with or without butterfly nuts, or equivalents, each of which is included within the meaning of “connection members” as used herein.

In at least one embodiment, the cup holder comprises two elastic ring suspenders 15, which are attached to the support ring 10 symmetrically on opposite sides of the ring 10. For example, in this embodiment the elastic ring suspenders 15 are attached to the support ring 10 at a radial spacing of 180 degrees. This two-point manner of attachment allows three-dimensions of mobility of the support ring 10 relative to the support bracket 99. For example, the two-point manner of attachment allows the support ring 10 to receive vertical suspension support from the elastic ring suspenders 15 while being permitted to laterally sway and swing in relation to the support bracket 99. This vertical and lateral mobility reduces the propensity for the beverage to spill as the bicycle or hand cart jostles while in motion.

The elastic ring suspenders 15 are any elastic member configured to vertically suspend the support ring 10 under the load of the beverage container. The elastic ring suspenders 15 could be springs, rubber elastic straps, or any other elastic member adapted to vertically suspend the support ring 10. The stiffness of the elastic ring suspenders 15 should be selected so that the elastic ring suspenders 15 do not reach maximum extension (i.e. “bottom out”) when the cup holder supports the weight of a full beverage experiencing significant jostling. The stiffness of each of the elastic ring suspenders 15 should be relatively equal to prevent off-center movement of the beverage. In other words, a plurality of elastic ring suspenders 15 of substantially similar stiffness will ensure that the center of stiffness of the suspenders aligns with the center of mass of the beverage, thus preventing awkward, off-balance movement of the beverage when the bicycle or hand cart is in motion.

The elastic ring suspenders 15 are fabricated from material suitable for the environmental conditions of the intended use. For example, where the cup holder 1 is intended for use on a “beach cruiser” bicycle, the elastic ring suspenders 15 comprise coated metal springs, plastic springs, or elastic straps that remain resilient in the corrosive ocean-side environment. The metal springs can be coated with paint, rubber, plastic, or a galvanizing layer to reduce oxidation in a corrosive environment. By contrast, in a less corrosive environment, uncoated metal springs can be used as elastic ring suspenders 15.

The support ring 10 is a rigid or semi-rigid ring providing annular suspension support to the basket 20. The support ring 10 is configured to accommodate a variety of beverage container sizes and shapes. The connection between the elastic ring suspenders 15 and the support ring 10 can be by a variety of typical connection members, as defined above. The same type of connection members can be used to attach the elastic basket suspenders 25 to the support ring 10.

A plurality of elastic basket suspenders 25 are disposed circumferentially around the support ring 10 and around the top of the basket 20. Each basket suspender 25 has an upper end and a lower end. The upper end of each basket suspender 25 is attached to the support ring 10, and the lower end of each basket suspender 25 is attached to the top of the basket 20, such that the basket 20 is suspended from the support ring 10 by the plurality of elastic basket suspenders 25. In one embodiment, the elastic basket suspenders 25 are disposed at equidistant radial intervals about the respective circumferences of the support ring 10 and the top of the basket 20. For example, in an embodiment comprising three elastic basket suspenders 25, the suspenders are spaced 120 degrees apart around the respective circumferences of the support ring 10 and the basket 20. In an embodiment comprising four elastic basket suspenders 25, the suspenders are spaced at 90 degrees around these respective circumferences. This equidistant radial spacing promotes alignment of the center of stiffness of the elastic basket suspenders 25 with the center of mass of the beverage, as discussed above. An ordinary practitioner will understand that alignment between the centers of stiffness and mass reduces the propensity for jostled beverages to spill.

The elastic basket suspenders 25 are springs, elastic straps, or any other elastic material adapted to elastically suspend the basket 20. The stiffnesses of the elastic basket suspenders 25 are selected so that the elastic basket suspenders 25 do not reach maximum extension (i.e. “bottom out”) when the cup holder 1 supports the weight of a full beverage experiencing significant jostling. The stiffness of each of the elastic basket suspenders 25 is preferably equal to prevent off-center movement of the beverage. In other words, a plurality of elastic basket suspenders 25 of substantially similar stiffnesses will promote alignment between the center of stiffness and the center of mass of the beverage, thus reducing awkward, off-balance movement of the beverage when the bike or hand cart is in motion. The elastic basket suspenders 25 are fabricated from material suitable for the environmental conditions of the intended use, as discussed above in the context of the elastic ring suspenders 15.

The basket 20 is substantially cylindrical in shape, the top being open to removably receive the beverage container, and the bottom having a base 30 to provide vertical support to the beverage container. In one embodiment, the basket 20 comprises a flexible or pliable sides, such as mesh, netting, or the like. In this embodiment, the basket 20 does not collect liquid, such as rainwater or spilled beverages. Instead, the permeable sides allow the basket 20 to drain unwanted liquid. In another embodiment, the sides of the basket 20 are rigid, either with or without drain holes disposed in the rigid sides.

The basket 20 can optionally comprise a collar 35 disposed near the top of the basket 20. The collar 35 is a rigid or semi-rigid ring configured to retain the top of the basket 20 in an open position for ease of inserting the beverage container into, and removing it from, the basket 20. The collar 35 is particularly useful in embodiments of the basket 20 having flexible sides that tend to collapse when the beverage container is removed from the basket 20. After the basket collapses, it can be difficult for the rider of a moving bicycle, for example, to insert the beverage container into the collapsed basket 20. The collar 35 holds the top of the basket 20 open to promote ease of inserting the beverage container into the basket 20.

Referring to FIG. 3, the basket base 30 is any substantially horizontal member capable of abutting the bottom of a beverage container to provide vertical support to the container. In embodiments where the basket 20 has flexible sides, the base 30 could be a portion of the basket 20 material sewn together to form a pouch at the bottom of the basket 20. Alternately, the base 30 could be a flexible member, such as a mesh material, connected to the bottom of the sides of the basket 20, such as by sewing. In another embodiment, the base 30 is a plate-like member connected to the bottom of the basket 20 sides. In this embodiment, the base 30 is a rigid or semi-rigid upon which the beverage container sits. In another embodiment, the base 30 is weighted to ensure that the bottom of the basket 20 hangs below the support ring 10. The weighted base 30 is particularly useful to prevent entanglement of an empty suspended cup holder 1 that is jostled while the bicycle is in motion. Finally, in any of the foregoing embodiments, the base 30 can comprise drain holes to promote drainage of unwanted liquid from the basket 20.

The foregoing embodiments are merely representative of the suspended cup holder and not meant for limitation of the invention. For example, one having ordinary skill in the art would understand that many suspension components described herein can be customized for specific applications by an ordinary practitioner. Consequently, it is understood that equivalents and substitutions for certain elements and components set forth above are part of the invention, and therefore the true scope and definition of the invention is to be as set forth in the following claims.

What is claimed is:

1. A suspended cup holder for attachment to a bicycle or hand cart, said suspended cup holder comprising:
a support ring;
a plurality of elastic ring suspenders, each ring suspender having a top end and a bottom end, said top end connected to a support bracket, and said bottom end connected to the support ring such that the support ring is suspended from the support bracket by the elastic ring suspenders, said support bracket adapted for attachment to a bicycle or hand cart;
a basket; and
a plurality of elastic basket suspenders having an upper end and a lower end, said upper end connected to the support ring and said lower end connected to the basket such that the basket is suspended from the support ring by the plurality of elastic basket suspenders.

2. The suspended cup holder of claim 1, comprising two elastic ring suspenders.

3. The suspended cup holder of claim 1, comprising three elastic basket suspenders.

4. The suspended cup holder of claim 1, comprising four elastic basket suspenders.

5. The suspended cup holder of claim 2, wherein the elastic ring suspenders further comprise coated metal springs.

6. The suspended cup holder of claim 2, wherein the elastic ring suspenders further comprise plastic springs.

7. The suspended cup holder of claim 2, wherein the elastic ring suspenders further comprise elastic straps.

8. The suspended cup holder of claim 3, wherein the elastic basket suspenders further comprise coated metal springs.

9. The suspended cup holder of claim 4, wherein the elastic basket suspenders further comprise coated metal springs.

10. The suspended cup holder of claim 3, wherein the elastic basket suspenders further comprise plastic springs.

11. The suspended cup holder of claim 4, wherein the elastic basket suspenders further comprise plastic springs.

12. The suspended cup holder of claim 3, wherein the elastic basket suspenders further comprise elastic straps.

13. The suspended cup holder of claim 4, wherein the elastic basket suspenders further comprise elastic straps.

14. The suspended cup holder of claim 1, wherein the basket further comprises a collar disposed near the top of the basket.

15. The suspended cup holder of claim 1, wherein the basket further comprises a base.

16. The suspended cup holder of claim 14, wherein the basket further comprises a base.

17. The suspended cup holder of claim 4, wherein the basket further comprises a collar disposed near the top of the basket.

18. The suspended cup holder of claim 4, wherein the basket further comprises a base.

19. A suspended cup holder for attachment to a bicycle or hand cart, said suspended cup holder comprising:
a support ring;
a two elastic ring suspenders, each ring suspender having a top end and a bottom end, said top end connected to a support bracket, and said bottom end connected to the support ring such that the support ring is suspended from the support bracket by the elastic ring suspenders, said support bracket adapted for attachment to a bicycle or hand cart;
a basket; and
four elastic basket suspenders, each basket suspender having an upper end and a lower end, said upper end connected to the support ring and said lower end connected to the basket such that the basket is suspended from the support ring by the elastic basket suspenders, and said basket having a collar disposed near the top of the basket.

20. The suspended cup holder of claim 19, wherein the basket further comprises a base.
